(19) United States
(12) Patent Application Publication
(10) Pub. No.: US 2011/0133746 A1
(43) Pub. Date: Jun. 9, 2011

(54) Discharge Ionization Current Detector

(75) Inventors: Kei SHINADA, Uji (JP); Katsuhisa KITANO, Ibaraki (JP)

(73) Assignees: SHIMADZU CORPORATION, Kyoto-shi (JP); OSAKA UNIVERSITY, Osaka (JP)

(21) Appl. No.: 12/912,646

(22) Filed: Oct. 26, 2010

(30) Foreign Application Priority Data
Dec. 4, 2009 (JP) JP2009-276091

(51) Int. Cl. G01N 27/62

(52) U.S. Cl. 324/464

(57) ABSTRACT

To reduce the cost of a high-voltage power supply unit by reducing the discharge starting voltage for a low-frequency dielectric barrier discharge.

Means for Solution: Light from light source unit 20 located externally to cylindrical tube 2 through which a plasma gas (He) flows is irradiated through the wall surface of the cylindrical tube 2 onto a plasma generation region (the region between plasma generation electrodes 6 and 7) located in gas flow path 4. The light energy excites the He molecules or the minute quantities of impurity gas molecules present in the He gas, causing photo-ionization. This causes a discharge to start, and a plasma to be formed, when a low-frequency voltage of a voltage that is less than the usual discharge starting voltage is applied across electrode 5 and electrodes 6, 7. Once the discharge starts, the discharge is sustained when the usual discharge sustaining voltage is applied across electrode 5 and electrodes 6, 7. This means that the light source unit 20 has to be on only for a short duration when discharging is started.

### TECHNICAL FIELD

The present invention relates to a discharge ionization current detector often used as a detector in gas chromatography (GC) and relates more specifically to a discharge ionization current detector that uses a low-frequency barrier discharge.

### BACKGROUND ART

Detectors employing various methods have previously been used as detectors for gas chromatography. Examples include thermal conductivity detector (TCD), electron capture detector (ECD), flame ionization detector (FID), flame photometry detector (FPD) and flame thermionic detector (FTD). Among such detectors, the one that is most commonly used, in particular, for the detection of organic substances is a flame ionization detector. With flame ionization detectors, a hydrogen flame is used to ionize the specimen components that are present in a specimen gas, and the ion current is measured. The dynamic range of flame ionization detectors is wide and reaches approximately 6 digits. However, flame ionization detectors have shortcomings such as: (1) because of the low ionization efficiency, the minimum detectable quantity is not very low, (2) the ionization efficiency of alcohols, aromatic group and chlorine-based substances is low and (3) the need to use hydrogen poses a hazard and requires the use of specialized facilities such as explosion-proof facilities.

Another example of a previous detector known for its ability to detect a range of substances from inorganic substances to organic compounds having a low boiling point with a high sensitivity is pulsed discharge ionization current detector (PDD: pulsed discharge detector) (see. Patent Literature 1 and others). Pulsed discharge detectors use high-voltage pulsed discharge to excite molecules such as helium molecules and use the light energy that is generated when molecules in the excited state returns to a ground state to ionize the molecules being analyzed. The ion current created by the generated ions is detected to obtain a detection signal that corresponds to the quantity (concentration) of the molecules being analyzed.

Pulsed discharge detectors are generally capable of achieving a higher ionization efficiency than flame ionization detectors. As one example, the ionization efficiency of flame ionization detectors when working with propane is only about 0.0005% in contrast to the ionization efficiency of about 0.07% in the case of pulsed discharge detectors. However, the dynamic range of pulsed discharge detectors is less than that of flame ionization detectors by about one order of magnitude. This is one of the reasons that pulsed discharge detectors are not as prevalent as flame ionization detectors.

The factors that restrict the dynamic range of previous pulsed discharge detectors are believed to be the instability of the plasma caused by ionization and the cyclical variation in the plasma state. In response to this, to achieve a stable steady-state plasma state, discharge ionization current detector that uses low-frequency AC excitation dielectric barrier discharge (hereinafter “low-frequency barrier discharge”) has been proposed (see Patent Literature 2 and the like). The plasma that is generated by a low-frequency barrier discharge is an atmospheric pressure non-equilibrium plasma which, unlike plasma created by a high-frequency discharge, does not easily reach a high temperature. Furthermore, the cyclical variation caused by state transition of the applied voltage that can happen with plasma created by pulsed high voltage excitation is also suppressed. This means that a stable, steady-state plasma state is more easily obtained. For these reasons, the inventors of the present application have made various proposals and engaged in studies regarding discharge ionization current detectors that use low-frequency barrier discharge (see, among others, Patent Literature 3 and Non-Patent Literature 1 and 2).

### PRIOR ART LITERATURE

### Patent Literature

Patent Literature 1: Specification of U.S. Pat. No. 5,394,092
Patent Literature 2: Specification of U.S. Pat. No. 5,892,364
Patent Literature 3: International Publication 2009/119050 Pamphlet

### Non-Patent Literature

Non-Patent Literature 1: Shinada and three others, “Ionization Current Detector for Gas Chromatography That Uses Atmospheric Pressure Microplasma,” Joint Proceedings of the 2008 Spring 55th Seminar of the Japan Society of Applied Physics
Non-Patent Literature 2: Shinada and three others, “Ionization Current Detector for Gas Chromatography That Uses Atmospheric Pressure Microplasma (II),” Joint Proceedings of the 2008 Spring 69th Seminar of the Japan Society of Applied Physics

### SUMMARY OF THE INVENTION

### Problems to be Solved by the Invention

As afore-described, the advantage of low-frequency barrier discharge is the stable plasma state. Another advantage is its low noise. Another general property is the large difference between the discharge starting voltage required for generating a plasma and the discharge sustaining voltage. Because of this, a low-frequency barrier discharge has to be controlled so that a sufficiently high voltage (usually 1.5-fold or more of the discharge sustaining voltage) is temporarily applied to the plasma generation electrode to start a discharge which is then lowered to a predetermined discharge sustaining voltage once the discharge is started. Since the discharge starting voltage changes depending on the type and purity of the plasma gas that is used, ensuring that the discharging starts without fail requires the use of a high voltage power supply that can generate a voltage that is greater than the discharge sustaining voltage by 2-fold or more. A problem then is the need to use an expensive power supply which translates to the system itself becoming expensive.

The present invention has been made to solve the afore-described problems, and it is the object of the present invention to provide a discharge ionization current detector wherein a low-frequency barrier discharge is stably started using a low voltage that is roughly the same as the discharge sustaining voltage, thereby reducing the cost of the voltage power supply required for the generation of the plasma.

### Means for Solving the Problems

In a discharge ionization current detector including a pair of electrodes of which at least one of the surfaces is covered by a dielectric, a discharge generation means that includes a voltage application means for applying a low-frequency AC voltage to the electrodes so as to generate plasma from a predetermined gas by the discharge, and a current detection means that detects ion current derived from gaseous specimen components ionized by the effects of the generated plasma, the present invention which has been made to solve the afore-described problems includes a light irradiation means for irradiating with light a plasma generation region created by the discharge generation means, wherein the light irradiation performs light irradiation when the voltage application means applies a low-frequency AC voltage to the electrodes to start the discharge.

Examples of predetermined gases include any one or a gas mixture of helium, argon, nitrogen, neon and xenon.

The range of the frequency of the low-frequency AC voltage that is applied to the electrodes is approximately 1 kHz to 100 kHz and preferably between approximately 5 kHz to 50 kHz.

With a discharge ionization current detector related to the present invention, when the plasma generation region is irradiated by light that is emitted by the light irradiation means, the molecules of a predetermined gas (or impurities mixed in the predetermined gas) present near the region are excited by the light energy, and some of the molecules may be photo-ionized. This creates a situation where a discharge is likely to occur, and a discharge starts at a voltage lower than the discharge starting voltage that is ordinarily required. Once the discharge starts, the discharge is continued by the application to the electrodes of a discharge sustaining voltage that is lower than the usual discharge starting voltage, thus forming a stable plasma. This means that the light irradiation from the light irradiation means can be stopped once the discharge starts.

Because of the afore-described, a preferable mode of the discharge ionization current detector according to the present invention can be a configuration that includes a control means for controlling a light irradiation means so that irradiation with light occurs when a low-frequency AC voltage from a voltage application means is applied to the electrodes or for a predetermined amount of time after the start of the application [of the low-frequency AC voltage].

With this configuration, sine the light irradiation means is driven only for a short amount of time at the start of the discharge, the service life of the light irradiation means is extended while also suppressing the power consumption by the light irradiation means.

There is no limitation on the type of the light source as long as the light irradiation means is capable of supplying the light energy required for excitation and photo-ionization. However, it is desirable for the light emitting brightness to be high. However, from the perspectives of service life and cost, a light emitting diode (LED) is preferable. Also, since the light energy is greater with a shorter wavelength, it is preferable for the wavelength to be shorter than that of orange for a wavelength in the visible light band. Needless to say, it is better to use ultraviolet light whose wavelength is shorter than that of visible light.

One mode of a discharge ionization current detector according to the present invention is a configuration wherein a predetermined gas is made to flow through a light transmissive tube with the light irradiation means positioned externally to the tube. This configuration prevents contaminants originating from the light irradiation means from mixing with the predetermined gas. This configuration also simplifies the maintenance work on the light irradiation means such as its replacement.

### Effects of the Invention

With the discharge ionization current detector according to the present invention, whereas the starting voltage for a low-frequency barrier discharge usually has to be approximately 2-fold or more of the discharge sustaining voltage, the starting voltage can be reduced to approximately the discharge sustaining voltage, consequently obviating the need to supply a high discharge starting voltage to the electrodes used for plasma generation. Furthermore, the control required for increasing and decreasing the high voltage is made unnecessary. Because of these things, an expensive high voltage power supply required solely for applying a discharge starting voltage becomes unnecessary, thus allowing the apparatus to be provided at a low cost.

### BRIEF DESCRIPTION OF THE FIGURES

FIG. 1 shows a schematic view of the configuration of one embodiment of a discharge ionization current detector according to the present invention.

FIG. 2 is a timing chart showing the operation and the effects of the present embodiment of the discharge ionization current detector.

### EMBODIMENTS OF THE INVENTION

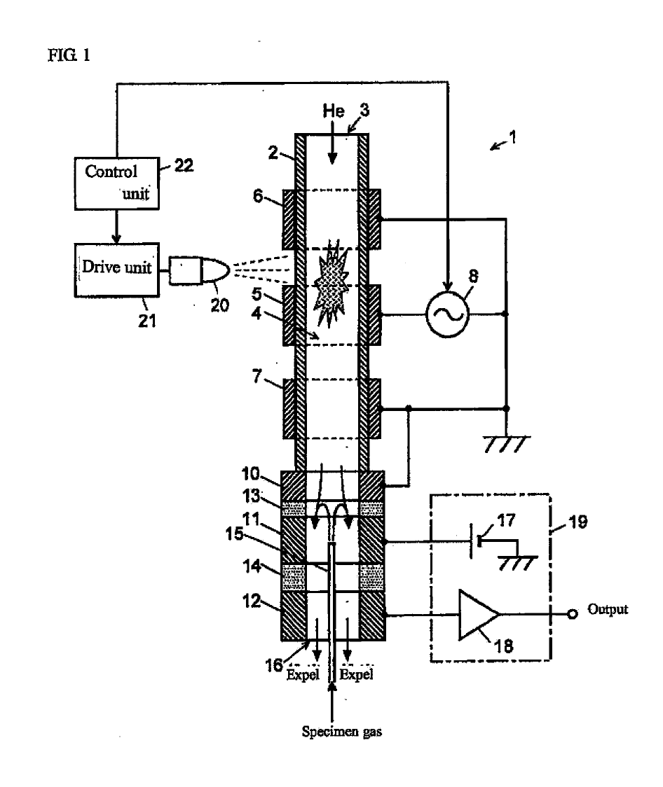

One embodiment of a discharge ionization current detector according to the present invention is described next with reference to the attached figures. FIG. 1 shows a schematic view of the configuration of one embodiment of a discharge ionization current detector according to the present invention.

The present embodiment of the discharge ionization current detector 1 includes a cylindrical tube 2 made of a light transmissive dielectric such as quartz, the interior of which serves as a gas flow path 4. As an example, a quartz tube with an outer diameter of φ3.9 mm can be used as cylindrical tube 2. Annular plasma generation electrodes 5, 6 and 7 made of a metal (such as SUS and copper), separated by a predetermined distance, are disposed along the periphery of the outer wall surface of the cylindrical tube 2. Since the wall surface of cylindrical tube 2 is interposed between the plasma generation electrodes 5, 6 and 7 and the gas flow path 4, the wall surface which is made of a dielectric material functions as a dielectric cover layer that covers the surface of the electrodes 5, 6 and 7, thus enabling a dielectric barrier discharge.

Among the three plasma generation electrodes 5, 6 and 7, an excitation high-voltage power supply 8 is connected to the center electrode, electrode 5. The two electrodes, electrodes 6 and 7, which are positioned on both sides of the electrode 5, above and below, are both grounded. By using a structure wherein electrode 5 to which a high voltage is applied is bordered on both sides with two grounded electrodes 6 and 7, the plasma that is generated by a discharge is prevented from spreading to the upstream side and the downstream side of the gas, thus confining the substantial plasma generation region to the region bounded by the two plasma generation electrodes 6 and 7.

The excitation high-voltage power supply 8 generates a low frequency, high voltage AC voltage whose frequency ranges between 1 kHz and 100 kHz and preferably between 5 kHz and 50 kHz. The waveform of the AC voltage can be any one of a sine wave, square wave, triangle wave, sawtooth wave, and the like.

Disposed at the lower side (downstream side of the gas flow) of the cylindrical tube 2, separated by insulators 13 and 14 such as alumina, PTFE resin and the like, are a recoil electrode 10, bias electrode 11 and ion collection electrode 12 in sequence according to the gas flow. These are all cylindrical objects having an identical inner diameter and form, by means of their inner surface, a gas flow path that connects to the gas flow path 4 formed within the cylindrical tube 2, thus meaning that the electrodes 10, 11 and 12 are directly exposed to the gas present within the flow path. A capillary tube 15 is inserted into the gas flow path from the gas exhaust opening that is formed at the bottom end. A specimen gas containing the specimen components to be detected is supplied through the capillary tube 15 at a predetermined flow rate.

The recoil electrode 10 is grounded, thereby preventing the charged particles in the plasma from reaching ion collection electrode 12 at the downstream side. This reduces noise and improves the S/N ratio. The bias electrode 11 is connected to the bias DC power supply 17 that is included in the ion current detector 19. The ion collection electrode 12 is connected to the current amplifier 18 that is included in the ion current detector 19.

A characteristic configuration of the present embodiment of the discharge ionization current detector 1 is the disposition of light source unit 20 at a position external to the cylindrical tube 2 so that light is emitted to the peripheral surface of the cylindrical tube 2 (in fact, toward the plasma generation region gas flow path 4 in the gas flow path 4). The light source unit 20 is, for example, a white LED light (of approximately 3 W). The distance separating the light source unit 20 and the outer peripheral surface of the cylindrical tube 2 is, for example, approximately 10 mm to 15 mm. The drive unit 21 is controlled by a control unit 22 that is equipped with a CPU and the like and turns the light source unit 20 on and off. The control unit 22 also controls the turning on and off of the excitation high-voltage power supply 8.

The detection operation performed by the discharge ionization current detector 1 is described next. As the downward arrow in FIG. 1 shows, helium is supplied as the plasma gas through the gas supply opening 3 at a predetermined flow rate. Also, as the upward arrow in FIG. 1 shows, a specimen gas is supplied to capillary tube 15. In addition to helium, any one species or a mixture of two or more species of a gas that is easily ionized such as argon, nitrogen, neon, xenon and the like can be used as the plasma gas.

The helium gas flows downwardly in the gas flow path 4, joins with the specimen gas that is supplied through the capillary tube 15, flows downwardly in the flow path along the outside of the capillary tube 15 and is ultimately discharged from the gas exhaust opening 16 that is located at the bottom end.

As afore-described, while the helium gas is flowing through the gas flow path 4, the excitation high-voltage power supply 8 is driven by control signals from the control unit 22. The excitation high-voltage power supply 8 applies a low frequency, high voltage AC voltage across electrode 5 and electrode 6 and across electrode 5 and electrode 7 used for plasma generation. The control unit 22 issues instructions to drive unit 21 so that the light source unit 20 is turned on either at the same time with the application of the voltage, with a predetermined amount of time delay or in advance by a predetermined amount of time. Cylindrical tube 2 is made of quartz (synthetic quartz) that allows the passage of light with a wavelength in the range of approximately 170 nm to 2200 nm. This means that the light that is emitted by the light source unit 20 passes through the peripheral walls of the cylindrical tube 2 and becomes incident to the helium gas that is flowing through the gas flow path 4. When this happens, the light energy excites the helium molecules or the minute quantities of impurity gas molecules that are present in the helium gas. If the ionization energy is exceeded, photo-ionization occurs.

This causes the plasma generation region within the gas flow path 4 that is bounded by electrodes 6 and 7 to be in a state where discharge easily occurs, thus causing a discharge to occur between electrode 5 and electrode 6 and between electrode 5 and electrode 7 even when the low-frequency AC voltage that is applied between electrode 5 and electrode 6 and between electrode 5 and electrode 7 is a voltage that is so low that a discharge would not normally start (without light irradiation). Since this discharge occurs through a dielectric cover layer (cylindrical tube 2), the discharge is a dielectric barrier discharge. The dielectric barrier discharge causes a wide ionization of the helium gas that flows through the gas flow path 4 and generates a plasma (atmospheric pressure non-equilibrium microplasma).

The excitation light or the excited helium species that is emitted from the atmospheric pressure non-equilibrium microplasma that is generated as afore-described passes through the gas flow path 4 and reaches where the specimen gas is present, ionizing the specimen components molecules (or atoms) present in the specimen gas. Because of the effects of the bias DC voltage that is applied to the bias electrode 11, the specimen ions in the specimen gas receive electrons from the ion collection electrode 12. This results in the quantity of the specimen ions that are generated to be input to the current amplifier 18, that is, an ion current corresponding to the quantity of specimen components is input to the current amplifier 18. The current amplifier 18 amplifies the ion current and outputs the amplified current as the detection signal. In this way, the discharge ionization current detector 1 outputs a detection signal that corresponds to the quantity (concentration) of specimen components that are included in the specimen gas that was introduced.

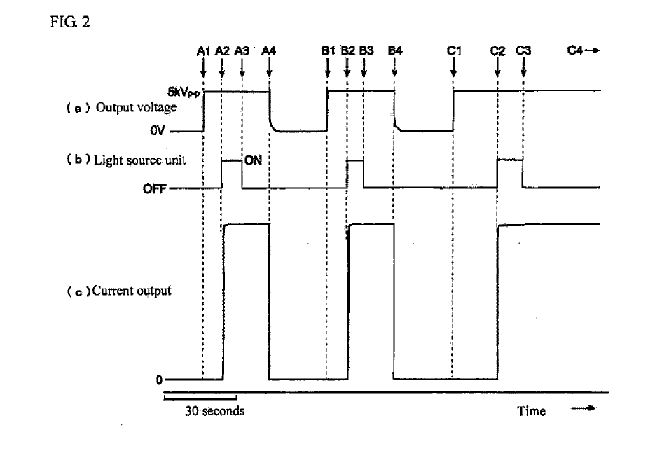

FIG. 2 shows a timing chart showing the timings that were used in an experiment that was performed to confirm the reduction in discharge starting voltage that is achieved by irradiating with light from light source unit 20 when discharge is started. In this experiment, the voltage and the frequency of the output voltage (sine wave voltage) from the excitation high-voltage power supply 8 was fixed to 5 kVₚ₋ₚ and 15 kHz, respectively, and the excitation high-voltage power supply 8 was turned on and off using the timings shown in FIG. 2(a). The light source unit 20 was turned on after a predetermined time delay (from approximately several seconds to approximately 10 to 20 seconds) after turning on the power supply 8. The light source unit 20 was kept on continuously for a predetermined amount of time (from approximately 7 to 10 seconds) and then turned off (FIG. 2(b)). The current output at that time was monitored (FIG. 2(c)). Without the light irradiation, the discharge starting voltage was approximately 8 kVₚ₋ₚ and the discharge sustaining voltage was approximately 4 kVₚ₋ₚ for the discharge ionization current detector 1.

Since a discharge does not occur when the output voltage of the excitation high-voltage power supply 8 is 0V and the light source unit 20 is off, the current output is 0. The output voltage is raised to 5 kVₚ₋ₚ at time A1, but no discharge starts since this is lower than the discharge starting voltage in the absence of light irradiation, and the current output remains 0. When the light source unit 20 is turned on at time A2, discharge starts immediately, and the current output increases. Since the output voltage at this time is higher than the discharge sustaining voltage, the discharge continues even when the light source unit 20 is turned off at time A3, and the current output is maintained. That is, once the discharge is started, the condition under which the specimens can be detected is maintained even when the light source unit 20 is turned off. When the output voltage of the excitation high-voltage power supply 8 is reduced to 0 at time A4, the discharge stops, and the current output becomes 0. A similar sequence is repeated at times B1 to B4 and C1 to C4, thus confirming that discharge is triggered by the light irradiation from the light source unit 20.

The purpose of the operation timing shown in FIG. 2 is to confirm that the discharge is triggered by light irradiation. In an actual apparatus, needless to say, the light source unit 20 may be turned on at the same time as the start of the application of the voltage from the excitation high-voltage power supply 8 or may be turned on in advance of starting the application of the voltage. Stated differently, there are no limitations imposed on the timing relationship between the start of application of the voltage from the excitation high-voltage power supply 8 and the turning on of the light source unit 20. What is important is that there be an overlap of more than a predetermined duration between the time during which a predetermined voltage is being applied from the excitation high-voltage power supply 8 and the time during which the light source unit 20 is turned on (duration of light irradiation). Once the discharge starts, the light irradiation is no longer necessary, and the light source unit 20 can be turned off at any time.

As afore-described, the results of FIG. 2 were obtained when using a 3 W white LED light as the light source unit 20. However, experiments have confirmed that similar results are obtained when, instead of a white LED light, an ultraviolet LED (wavelength: 400 nm, power supply voltage: 3V, rated current: 20 mA), blue LED (wavelength: 470 nm, power supply voltage: 3V, rated current: 20 mA), green LED (wavelength: 520 nm, power supply voltage: 3V, rated current: 20 mA) or orange LED (wavelength: 592 nm, power supply voltage: 2V, rated current: 20 mA) is used.

In other words, the discharge starts so long as a light energy of some quantity or more is provided to the plasma generation region. Since the light energy becomes higher as the wavelength becomes shorter, it is preferable to irradiate with light of a shorter wavelength. From this perspective, it is more efficient to use light in the ultraviolet region whose wavelength is shorter than that of even blue. According to experiments by the inventors, with an ultraviolet LED or a blue LED, discharge occurs when the distance to the cylindrical tube 2 is about 10 mm, but when light of a longer wavelength such as a green LED or an orange LED is used discharge did not occur until the distance became less than 5 mm.

When irradiating the gas flow path with light through the wall surface of the cylindrical tube 2 as in the afore-described configuration, the wavelength dependence of the light transmissive property of the wall surface must also be considered. Needless to say, an electronic flash (strobe) and the like can be used as light source unit 20 instead of an LED.

The afore-described embodiment is just one example of the present invention, and it goes without saying that various modifications, changes and additions can be made within the scope of the gist of the present invention and still be covered by the claim.

### DESCRIPTION OF THE NUMERICAL REFERENCES

1. Discharge ionization current detector
2. Cylindrical tube
3. Gas supply opening
4. Gas flow path
5, 6, 7. Plasma generation electrode
8. Excitation high-voltage power supply
10. Recoil electrode
11. Bias electrode
12. Ion collection electrode
13, 14. Insulator
15. Capillary tube
16. Gas exhaust opening
17. Bias. DC power supply
18. Current amplifier
19. Ion current detector
20. Light source unit
21. Drive unit
22. Control unit

What is claimed is:

1. A discharge ionization current detector comprising:
a pair of discharging electrodes of which at least one of the surfaces is covered by a dielectric;
a discharge generation means comprising a voltage application means for applying a low-frequency AC voltage to said discharging electrodes to generate plasma from a predetermined gas by a discharge;
a current detection means for detecting ion current derived from gaseous specimen components ionized by the effects of the generated plasma; and
a light irradiation means for irradiating with light a plasma generation region created by said discharging electrodes.

2. The discharge ionization current detector according to claim 1, further comprising a control means for controlling said light irradiation means so that light is irradiated by said light irradiation means for a predetermined amount of time when the application of voltage to said discharging electrodes by said voltage application means starts or after the passage of a predetermined amount of time after the start of the application of voltage to said discharging electrodes by said voltage application means.

3. The discharge ionization current detector according to claim 1 or 2 wherein a LED is used as said light irradiation means.

4. The discharge ionization current detector according to claim 3 wherein a LED with a wavelength shorter than the wavelength equivalent to orange is used as said light irradiation means.
